(19) United States
(12) Patent Application Publication
(10) Pub. No.: US 2026/0061799 A1
(43) Pub. Date: Mar. 5, 2026

(54) CLOTHING VENTILATION APPARATUS AND METHOD FOR VEHICLE

(71) Applicant: HYUNDAI MOBIS CO., LTD., Seoul (KR)

(72) Inventors: Ji Soo SHIN, Yongin-Si (KR); Sung Joon AHN, Yongin-Si (KR); Seung Jae KIM, Yongin-Si (KR)

(73) Assignee: HYUNDAI MOBIS CO., LTD., Seoul (KR)

(21) Appl. No.: 19/046,897

(22) Filed: Feb. 6, 2025

(30) Foreign Application Priority Data
Aug. 27, 2024 (KR) 10-2024-0114732

(51) Int. Cl. B60H 1/00

(52) U.S. Cl. CPC B60H 1/00285

(57) ABSTRACT

A clothing ventilation apparatus for a vehicle according to one embodiment of the present invention may include a ventilation hanger mounted on a rear of a seat of the vehicle, a ventilation blower fan installed inside the ventilation hanger and discharging air through a discharge hole formed in a lower portion of the ventilation hanger, and a suction member installed on a lower portion of the seat, disposed below clothing, and suctioning the air discharged from the ventilation blower fan.

### CROSS-REFERENCE TO RELATED APPLICATIONS

This application claims priority to and the benefit of Korean Patent Application No. 10-2024-0114732, filed on Aug. 27, 2024, the disclosure of which is incorporated herein by reference in its entirety.

### TECHNICAL FIELD

The present invention relates to a clothing ventilation apparatus and method for a vehicle, and more particularly, to a clothing ventilation apparatus and method for a vehicle capable of ventilation through a ventilation hanger mounted on a rear of a seat of the vehicle.

### BACKGROUND

Generally, during a long trip in a car, drivers and passengers take off their outerwear, and at this time, the outerwear is placed on a seat, or when a typical hanger is provided, the outerwear is hung on the hanger and the hanger is hung on an assist handle provided on an upper side of a side door and stored.

In a case where clothes are stored inside a vehicle as described above, when a separate hanger is not provided, since clothes are placed on a seat, there is an inconvenience that the clothes easily get wrinkled and may be too wrinkled to wear afterwards, and when a typical hanger is present, since the hanger needs to be stored inside a vehicle compartment at all times, there is an inconvenience that the appearance of an interior of the vehicle compartment is negatively affected.

In addition, in a case where clothes get wet from rain, when the clothes are stored inside a vehicle compartment, the clothes do not dry and may smell, causing the condition of the clothes to get worse, and when clothes with food odors are stored inside the vehicle compartment, the odor may be unpleasant to passengers.

Therefore, there is a need for a hanger for hanging clothes inside a vehicle compartment, and there is a need for development of a clothing ventilation apparatus for a vehicle that enables clothes to be dried through ventilation while the clothes are hung on the hanger.

### SUMMARY

One embodiment of the present invention is directed to providing a clothing ventilation apparatus and method for a vehicle in which a hanger is installed at a rear of a seat of the vehicle, thereby improving utilization of space inside the vehicle and increasing convenience for a passenger.

One embodiment of the present invention is also directed to providing a clothing ventilation apparatus and method for a vehicle in which clothes can be dried through ventilation while hung on a hanger in a vehicle, thereby making it easy to manage clothing.

Objectives of the present invention are not limited to the above-mentioned objectives, and other unmentioned objectives should be clearly understood by those of ordinary skill in the art from the description below.

One embodiment of the present invention provides a clothing ventilation apparatus for a vehicle, the clothing ventilation apparatus including a ventilation hanger mounted on a rear of a seat of the vehicle; a ventilation blower fan installed inside the ventilation hanger and discharging air through a discharge hole formed in a lower portion of the ventilation hanger; and a suction member installed on a lower portion of the seat, disposed below clothing, and suctioning the air discharged from the ventilation blower fan.

A ventilation hole discharging air upward between the seat and the clothing may be installed on the lower portion of the seat.

A seat blower fan discharging the air suctioned into the suction member toward the ventilation hole may be installed on the lower portion of the seat.

The suction member may be installed to be movable forward and rearward on the lower portion of the seat.

The suction member may be provided as a plurality of suction members disposed parallel to each other in a left-right direction.

A suction hole extending to be inclined toward the clothing may be provided on a front end of the suction member.

The ventilation hanger may be mounted on a mounting portion provided on the seat, and the mounting portion may be electrically connected to a controller in the vehicle.

One embodiment of the present invention provides a clothing ventilation method for a vehicle, the clothing ventilation method including, while only the ventilation hanger operates, operating the ventilation blower fan and the seat blower fan to discharge the air suctioned into the suction member toward the ventilation hole, the ventilation hole being fully open.

The clothing ventilation method may include, while the ventilation hanger and a ventilation seat simultaneously operate, operating the ventilation blower fan and the seat blower fan to discharge the air suctioned into the suction member toward the ventilation hole, the ventilation hole being partially open.

In a case where a humidity level decreases by a predetermined reference or more during an operation of the ventilation hanger, the ventilation blower fan and the seat blower fan may be stopped, and the ventilation hole may be closed.

### BRIEF DESCRIPTION OF THE DRAWINGS

The above and other objects, features, and advantages of the present specification will become more apparent to those of ordinary skill in the art by describing exemplary embodiments thereof in detail with reference to the accompanying drawings, in which:

FIG. 1 is a view illustrating a clothing ventilation apparatus for a vehicle according to one embodiment of the present invention;

FIG. 2 is a view illustrating a ventilation hanger of the clothing ventilation apparatus for a vehicle according to one embodiment of the present invention;

FIG. 3 is a side view of a mounting state of the ventilation hanger of the clothing ventilation apparatus for a vehicle according to one embodiment of the present invention;

FIG. 4 is a view schematically illustrating a controller connection structure of the ventilation hanger of the clothing ventilation apparatus for a vehicle according to one embodiment of the present invention;

FIG. 5 is a view illustrating a pre-operation state of the clothing ventilation apparatus for a vehicle according to one embodiment of the present invention;

FIG. 6 is a view illustrating an operating state of the clothing ventilation apparatus for a vehicle according to one embodiment of the present invention;

FIG. 7 is a view illustrating an air discharge path of a ventilation hole during a clothing drying mode;

FIG. 8 is a view illustrating an air discharge path of the ventilation hole during a ventilation seat mode;

FIG. 9 is a side view of the air discharge path of the ventilation hole during the clothing drying mode;

FIG. 10 is a side view of the air discharge path of the ventilation hole during the ventilation seat mode;

FIG. 11 is a view illustrating an air flow during an operation of the clothing ventilation apparatus for a vehicle according to one embodiment of the present invention; and

FIG. 12 is a flowchart illustrating a clothing ventilation method for a vehicle according to one embodiment of the present invention.

### DETAILED DESCRIPTION

Since various modifications may be made to the present invention and the present invention may have various embodiments, particular embodiments illustrated in the drawings will be described in detail herein. However, it is not intended to limit the present invention to the particular embodiments, and all modifications, equivalents, and substitutes included in the spirit and technical scope of the present invention should be understood as belonging to the present invention. In describing the present invention, when detailed description of a related known art is determined as having the possibility of obscuring the gist of the present invention, the detailed description thereof will be omitted.

Terms including ordinals such as “first” and “second” may be used to describe various components, but the components are not limited by the terms. The terms are only used for the purpose of distinguishing one component from another component.

Terms used herein are only used to describe specific embodiments and are not intended to limit and/or restrict the present invention. A singular expression includes a plural expression unless the context clearly indicates otherwise. In the application, terms such as “include” or “have” should be understood as specifying that features, numbers, steps, operations, components, parts, or combinations thereof are present and not as precluding the possibility of the presence or addition of one or more other features, numbers, steps, operations, components, parts, or combinations thereof in advance.

In addition, throughout the specification, being “connected” may mean not only that two or more components are directly connected, but also that two or more components are indirectly connected through another component, two or more components are electrically connected instead of being physically connected, or two or more components are integrally formed despite being referred to with different names according to their positions or functions.

Further, when a certain component is described as being formed or disposed “on (above) or under (below)” another component, this includes a case in which one or more other components are formed or disposed between the two components as well as a case in which the two components come into direct contact with each other. In addition, “on (above) or under (below)” may indicate downward as well as upward based on one component.

Hereinafter, one embodiment of a clothing ventilation apparatus and method for a vehicle according to the present invention will be described in detail with reference to the accompanying drawings, and in the description with reference to the accompanying drawings, identical or corresponding components will be denoted by the same reference numerals, and overlapping description thereof will be omitted.

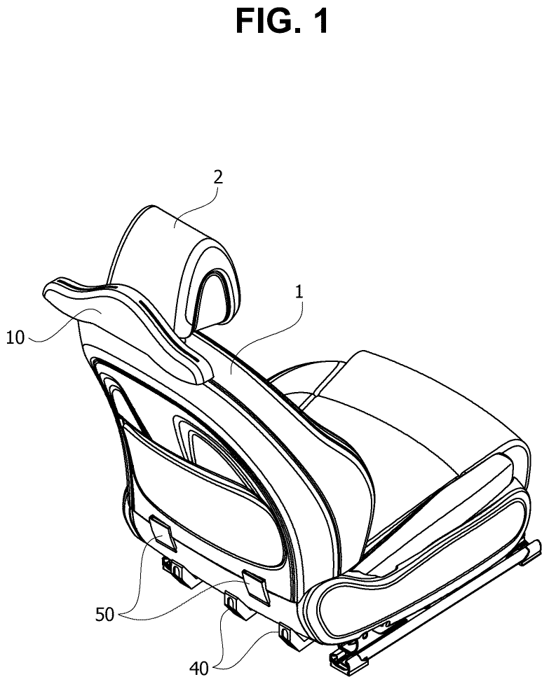

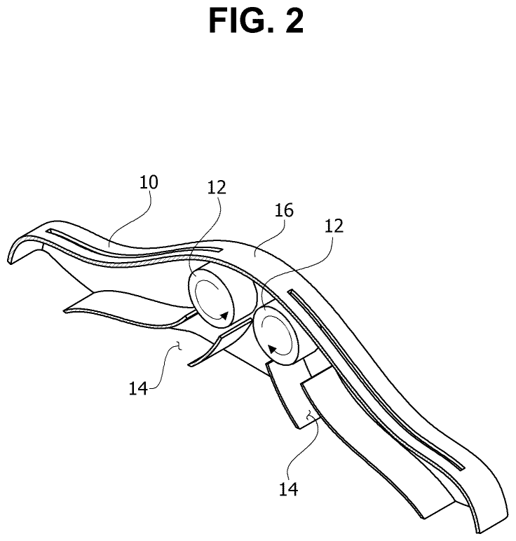

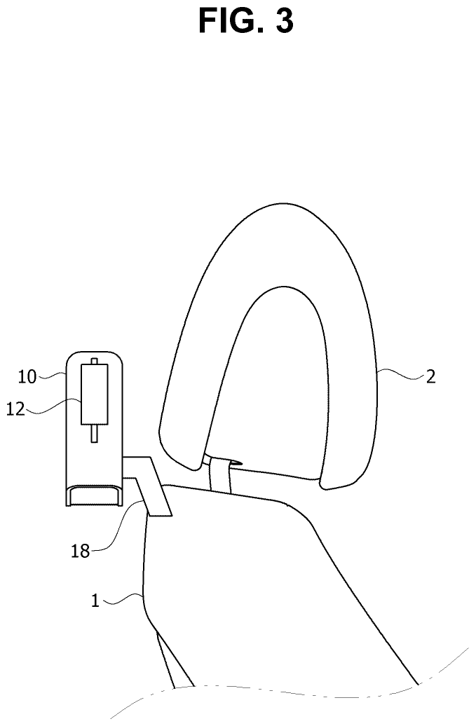

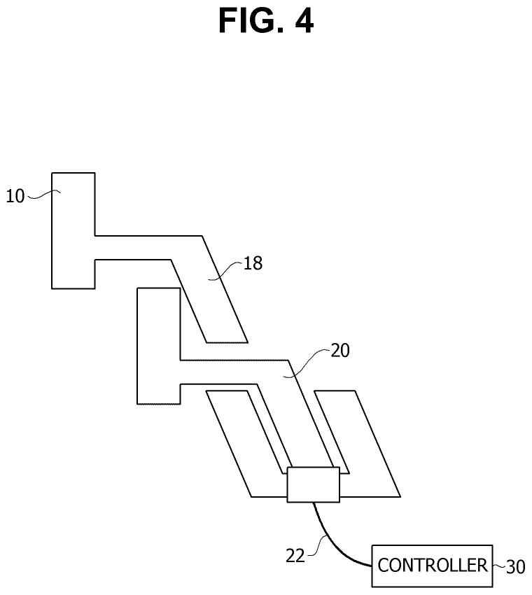

FIG. 1 is a view illustrating a clothing ventilation apparatus for a vehicle according to one embodiment of the present invention, FIG. 2 is a view illustrating a ventilation hanger of the clothing ventilation apparatus for a vehicle according to one embodiment of the present invention, FIG. 3 is a side view of a mounting state of the ventilation hanger of the clothing ventilation apparatus for a vehicle according to one embodiment of the present invention, and FIG. 4 is a view schematically illustrating a controller connection structure of the ventilation hanger of the clothing ventilation apparatus for a vehicle according to one embodiment of the present invention.

Referring to FIGS. 1 to 4, a clothing ventilation apparatus for a vehicle according to one embodiment of the present invention may include a ventilation hanger 10 mounted on a rear of a seat 1 of a vehicle, a ventilation blower fan 12 disposed at (e.g., installed inside) the ventilation hanger 10 and discharging air through a discharge hole 14 formed in a lower portion of the ventilation hanger 10, and a suction member 40 disposed at (e.g., installed on) a lower portion of the seat 1, disposed below clothing, and suctioning the air discharged from the ventilation blower fan 12.

The ventilation hanger 10 for ventilation of clothes hung thereon is mounted on the rear of the seat 1. The ventilation hanger 10 may be manufactured to have the form of a typical hanger and may be hollow to facilitate an air flow. The ventilation blower fan 12 for moving air and discharging the air to the outside is installed inside the ventilation hanger 10. As the ventilation blower fan 12, a pair of ventilation blower fans 12 may be disposed apart from each other as illustrated in FIG. 2, but the present invention is not limited thereto, and only one ventilation blower fan 12 may be installed.

The ventilation blower fan 12 discharges air toward the inside of the clothes hung on the ventilation hanger 10, thereby drying the clothes and removing a smell lingering on the clothes. In one embodiment, a pair of ventilation blower fans 12 may be disposed and may discharge air in directions opposite to each other.

The discharge hole 14 through which the air discharged by the ventilation blower fan 12 is discharged is formed to be open in the lower portion of the ventilation hanger 10. The discharge hole 14 may be formed at both sides of the lower portion of the ventilation hanger 10. A power button 16 may be provided on an upper portion of the ventilation hanger 10.

Referring to FIGS. 3 and 4, a connecting portion 18 extending for mounting of the ventilation hanger 10 on the seat 1 may be provided on one side of the ventilation hanger 10. The connecting portion 18 is a portion provided for attachment and detachment to and from the seat 1 and may be formed to extend toward the seat 1 and formed to be bendable according to a mounting angle.

In addition, a mounting portion 20 coupled to the connecting portion 18 of the ventilation hanger 10 is provided on an upper portion of the seat 1. In one embodiment, the mounting portion 20 may be configured to allow the connecting portion 18 to be coupled thereto by sliding, but the present invention is not limited thereto, and any other structure that can be coupled to the connecting portion 18 may be applied to the mounting portion 20.

A wire 22 is connected to a lower end of the mounting portion 20, and the wire 22 is electrically connected to a controller 30 of the vehicle. Accordingly, when the ventilation hanger 10 is mounted on the rear of the seat 1, since the ventilation hanger 10 is electrically connected to the controller 30, the ventilation hanger 10 may be controlled through in-vehicle infotainment (IVI) in the vehicle through a communication cable and may receive power and operate. That is, in a state in which the ventilation hanger 10 is mounted on the rear of the seat 1, power may be supplied thereto, and a passenger may press the power button 16 to operate the ventilation hanger 10.

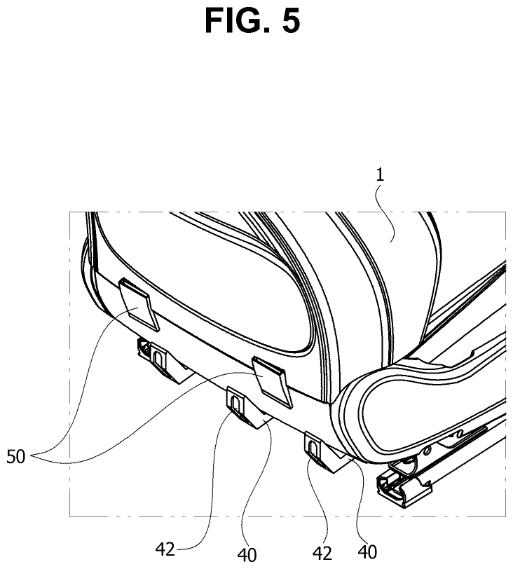

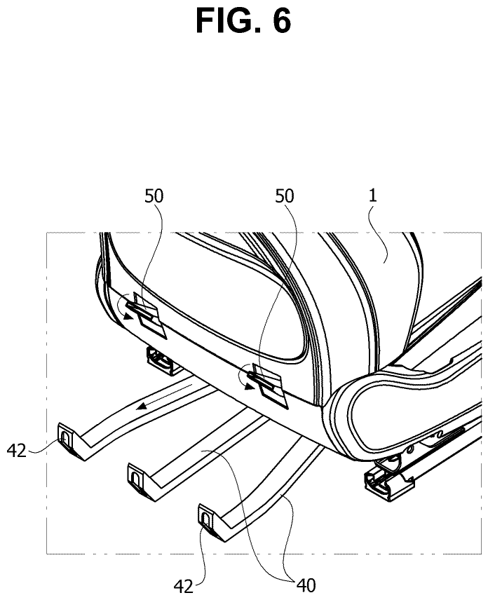

FIG. 5 is a view illustrating a pre-operation state of the clothing ventilation apparatus for a vehicle according to one embodiment of the present invention, and FIG. 6 is a view illustrating an operating state of the clothing ventilation apparatus for a vehicle according to one embodiment of the present invention.

Referring to FIGS. 5 and 6, the suction member 40 suctioning the air discharged from the ventilation blower fan 12 is movably installed on the lower portion of the seat 1. The suction member 40 may be installed to be movable forward and rearward through a space below the seat 1. That is, the suction member 40 may be installed to be slidable along a rail (not illustrated) installed below the seat 1. In one embodiment, a plurality of suction members 40 may be arranged in parallel (e.g., disposed parallel to each other in a left-right direction).

In addition, a suction hole 42 may be provided on a front end of the suction member 40, that is, an end of the suction member 40 that corresponds to a rear side of the vehicle. The suction hole 42 may extend to be inclined toward the clothing. In one embodiment, the suction hole 42 may extend to be inclined upward from the front end of the suction member 40 toward a rear thereof. The suction hole 42 extending in this way may extend toward a lower portion of the clothing or toward the inside of the lower portion of the clothing. Accordingly, when the air discharged from the ventilation blower fan 12 moves from an upper portion to a lower portion, the air may be suctioned through the suction hole 42 to facilitate movement of the air in the clothing. In the present embodiment, by discharging air through the ventilation hanger 10 at an upper portion of clothing and suctioning the discharged air at a lower portion of the clothing, air movement may be formed in the clothing to further facilitate drying of the clothing.

In addition, although not illustrated in detail in the drawings, a hook, a holder, etc., that can fix the clothing may be provided on the suction hole 42 to smoothly suction air through the suction hole 42 in a state in which a lower end of the clothing is fixed.

A ventilation hole 50 discharging air upward between the seat 1 and the clothing may be installed on the lower portion of the seat 1. A plurality of ventilation holes 50 may be installed on a rear surface of the lower portion of the seat 1. Although the ventilation holes 50 are illustrated as being installed on both sides of the lower portion of the seat 1 in the drawings, three or more ventilation holes 50 may be installed in the left-right direction on the lower portion of the seat 1.

The ventilation holes 50 serve to ventilate the clothing along with the ventilation hanger 10 and the suction member 40 that ventilate the clothing as described above. That is, the ventilation holes 50 discharge air between the clothing and a rear surface of the seat 1 to allow double ventilation to be performed through the inside and outside of the clothing. In this way, when air is also discharged to an outer portion of the clothing by the ventilation holes 50, since double ventilation is performed, the clothing can be quickly dried within a short period of time.

The ventilation holes 50 may be hinge-coupled to the rear surface of the seat 1 and may rotate a predetermined angle about a lower end thereof. The ventilation holes 50 may be configured to be closed, fully open, or partially open according to modes. This will be described in more detail below.

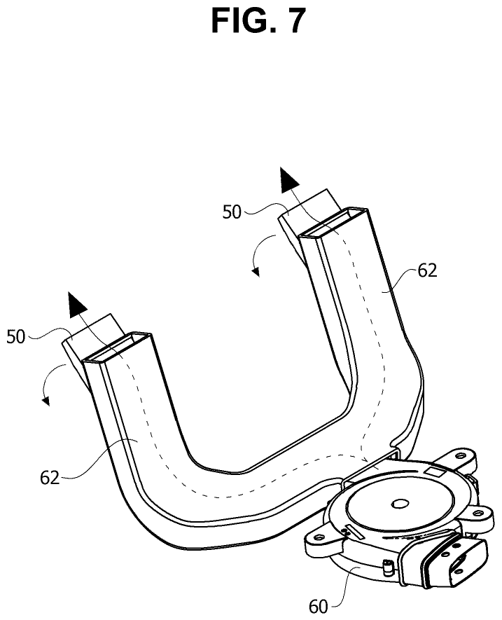

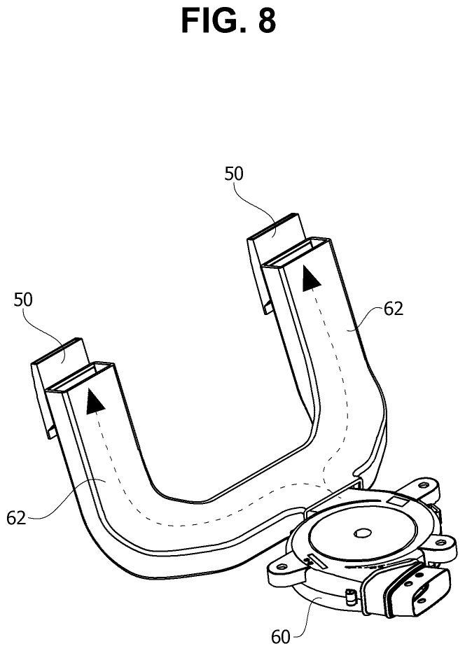

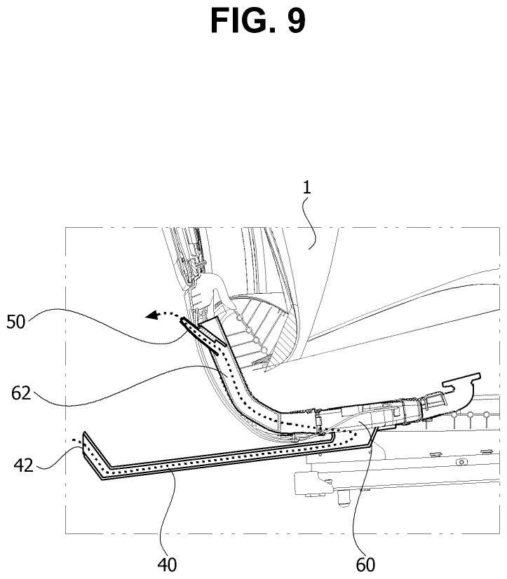

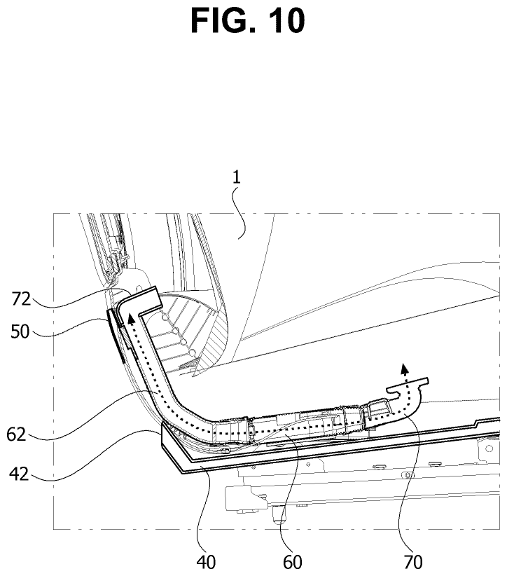

FIG. 7 is a view illustrating an air discharge path of a ventilation hole during a clothing drying mode, FIG. 8 is a view illustrating an air discharge path of the ventilation hole during a ventilation seat mode, FIG. 9 is a side view of the air discharge path of the ventilation hole during the clothing drying mode, and FIG. 10 is a side view of the air discharge path of the ventilation hole during the ventilation seat mode.

Referring to FIGS. 7 and 9, a seat blower fan 60 discharging the air suctioned into the suction member 40 toward the ventilation holes 50 is installed on the lower portion of the seat 1. In the present embodiment, the seat blower fan 60 may serve to discharge not only air for ventilating the clothing but also air necessary for a ventilation seat. The seat blower fan 60 may be seen as extending the application of an existing seat blower fan for discharging air necessary for a ventilation seat to ventilation of clothing.

The seat blower fan 60 is connected to a ventilation duct 62. The ventilation duct 62 may be formed to be split into two ducts, and each of the two ducts may be connected to one of the ventilation holes 50. Accordingly, air discharged from the seat blower fan 60 may be entirely or partially discharged through the ventilation holes 50.

During a clothing drying mode, the ventilation hanger 10 operates, and the air discharged by the ventilation blower fan 12 moves downward along the inside of the clothing. In addition, the suction member 40 moves rearward and is located below the clothing as illustrated in FIG. 9.

At this time, when the seat blower fan 60 operates, air is suctioned through the suction member 40 and discharged through the ventilation holes 50 via the ventilation duct 62. At this time, the ventilation holes 50 are fully open to allow the air to be discharged toward the clothing.

Referring to FIGS. 8 and 10, during a ventilation seat mode, the ventilation hanger 10 does not operate. Meanwhile, when the seat blower fan 60 operates, air may be discharged through the ventilation duct 62, and air may be discharged to a front surface of the seat through a second seat duct 72 connected to a top of the ventilation duct 62. In addition, air discharged from the seat blower fan 60 may be discharged to a lower surface of the seat through a first seat duct 70 disposed on the lower portion of the seat 1. At this time, since the ventilation holes 50 are closed, the air discharged from the seat blower fan 60 is discharged only to the front surface and lower surface of the seat 1 and performs a ventilation seat function.

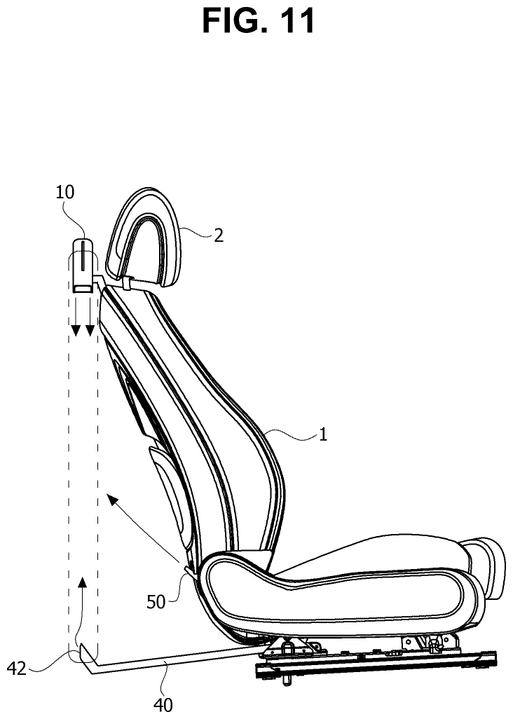

FIG. 11 is a view illustrating an air flow during an operation of the clothing ventilation apparatus for a vehicle according to one embodiment of the present invention.

Referring to FIG. 11, during the clothing drying mode, when the ventilation hanger 10 operates, the ventilation blower fan 12 may operate, and air may be discharged to the inside of the clothing through the discharge hole 14. Simultaneously, the suction member 40 moves to the rear of the seat 1 and is located below the clothing to suction the discharged air. Then, since rapid air movement occurs inside the clothing, effective drying of the clothing becomes possible.

In addition, when the ventilation holes 50 are open and the seat blower fan 60 operates, air suctioned through the suction member 40 is discharged through the ventilation holes 50. Then, the air moves between the seat 1 and the clothing, and the inner and outer portions of the clothing can be dried simultaneously.

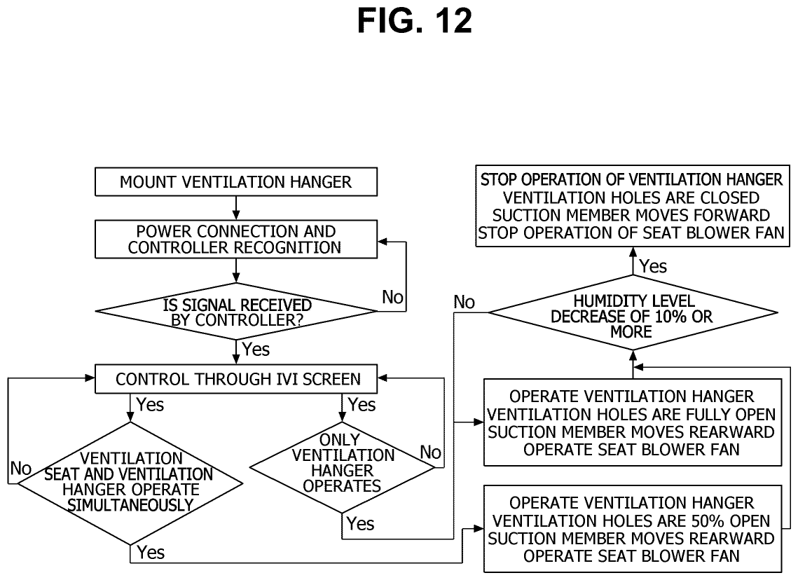

FIG. 12 is a flowchart illustrating a clothing ventilation method for a vehicle according to one embodiment of the present invention.

First, a passenger mounts the ventilation hanger 10 on the rear of the seat 1 to ventilate clothing inside a vehicle. Then, the ventilation hanger 10 and the controller 30 in the vehicle are electrically connected, power is supplied to the ventilation hanger 10, and the passenger is able to control the ventilation hanger 10 through an IVI screen. The passenger hangs clothing to be dried on the ventilation hanger 10.

Here, when a signal is received by the controller 30, the passenger may control a mode to a desired mode through the IVI screen.

In one embodiment, the passenger may simultaneously operate a ventilation seat and the ventilation hanger 10. Then, the ventilation hanger 10 operates, and air is discharged to the inside of the clothing through the ventilation blower fan 12. At this time, the ventilation holes 50 are only partially (for example, 50%) open. Also, the suction member 40 moves to the rear of the seat 1, and the seat blower fan 60 operates and suctions air. Due to the seat blower fan 60, the air may be discharged through the ventilation holes 50. Simultaneously, the air discharged by the seat blower fan 60 is discharged through the first seat duct 70 and the second seat duct 72 and performs a ventilation seat function.

That is, when the ventilation seat and the ventilation hanger 10 operate simultaneously, the ventilation holes 50 may only be partially open and perform the clothing drying function and the ventilation seat function simultaneously.

In one embodiment, the passenger may operate only the ventilation hanger 10. Then, the ventilation hanger 10 operates, and air is discharged to the inside of the clothing through the ventilation blower fan 12. At this time, the ventilation holes 50 are fully open. Also, the suction member 40 moves to the rear of the seat 1, and the seat blower fan 60 operates and suctions air. Due to the seat blower fan 60, the air may be discharged through the ventilation holes 50.

Meanwhile, when a decrease in a humidity level of 10% or more is detected by a humidity sensor while a ventilation function is performed as described above, the operation of the ventilation hanger 10 is stopped, and the ventilation holes 50 are closed. In addition, the suction member 40 moves forward, and the operation of the seat blower fan 60 is stopped. The decrease in the humidity level of 10% or more that is presented herein is only one example, and the operation control described above is performed in response to a decrease in the humidity level of a predetermined reference or more.

According to one embodiment of the present invention, since a hanger is installed at a rear of a seat of a vehicle, utilization of space inside the vehicle can be improved and convenience for a passenger can be increased.

In addition, according to one embodiment of the present invention, since clothes can be dried through ventilation while hung on a hanger in a vehicle, it becomes easy to manage clothing.

Although specific embodiments of the present invention have been described above, those of ordinary skill in the art should understand that various modifications and changes may be made to the present invention within the scope not departing from the spirit and range of the present invention defined in the claims below.

What is claimed is:

1. A clothing ventilation apparatus for a vehicle, comprising:
a ventilation hanger mounted on a rear of a seat of the vehicle and having, at a lower portion thereof, a discharge hole;
a ventilation blower fan disposed at the ventilation hanger and configured to discharge air through the discharge hole; and
a suction member disposed at a lower portion of the seat, below clothing, and configured to suction the air discharged from the ventilation blower fan.

2. The clothing ventilation apparatus of claim 1, wherein the seat has, at a lower portion thereof, a ventilation hole configured to discharge air upward between the seat and the clothing.

3. The clothing ventilation apparatus of claim 2, wherein the seat includes, at the lower portion thereof, a seat blower fan configured to discharge the air suctioned into the suction member toward the ventilation hole.

4. The clothing ventilation apparatus of claim 3, wherein the suction member is configured to be movable forward and rearward at the lower portion of the seat.

5. The clothing ventilation apparatus of claim 4, wherein the suction member comprises a plurality of suction members arranged in parallel.

6. The clothing ventilation apparatus of claim 4, wherein the suction member has, at a front end thereof, a suction hole extending inclined toward the clothing.

7. The clothing ventilation apparatus of claim 4, wherein:
the seat has a mounting portion electrically connected to a controller of the vehicle, and
the ventilation hanger is mounted on the mounting portion.

8. A clothing ventilation method for a vehicle including the clothing ventilation apparatus of claim 3, the clothing ventilation method comprising, while only the ventilation hanger operates, operating the ventilation blower fan and the seat blower fan to discharge the air suctioned into the suction member toward the ventilation hole, the ventilation hole being fully open.

9. The clothing ventilation method of claim 8, further comprising, while the ventilation hanger and a ventilation seat simultaneously operate, operating the ventilation blower fan and the seat blower fan to discharge the air suctioned into the suction member toward the ventilation hole, the ventilation hole being partially open.

10. The clothing ventilation method of claim 9, wherein, in response to a humidity level decreasing by a predetermined reference or more during an operation of the ventilation hanger, the ventilation blower fan and the seat blower fan are stopped, and the ventilation hole is closed.
